(19) United States
(12) Patent Application Publication
(10) Pub. No.: US 2025/0054237 A1
(43) Pub. Date: Feb. 13, 2025

(54) GENERATION OF DIGITAL TERRAIN

(71) Applicant: BRITISH TELECOMMUNICATIONS PUBLIC LIMITED COMPANY, London, Greater London (GB)

(72) Inventors: Jonathan ROSCOE, London, Greater London (GB); Tiago MARTINS ANDRADE, London, Greater London (GB); Oliver BAXANDALL, London, Greater London (GB)

(21) Appl. No.: 18/721,533

(22) PCT Filed: Nov. 8, 2022
(86) PCT No.: PCT/EP2022/081173

§ 371 Date: Jun. 18, 2024

(30) Foreign Application Priority Data
Dec. 20, 2021 (GB) 2118547.5

(51) Int. Cl. G06T 17/05; G06F 16/28; G06F 16/29; G06T 17/20

(52) U.S. Cl. CPC G06T 17/05; G06F 16/285; G06F 16/29; G06T 17/20

(57) ABSTRACT

A method for processing data performed by one or more processors, the method comprising: receiving input data that comprises a plurality of elements, each element comprising a plurality of attributes; and generating geometric data based on the input data by determining locations in a space for elements of the plurality of elements based on attributes of the elements and generating geometries in the space for the elements at the respective determined locations, wherein determining locations in the space for elements based on attributes of the elements comprises performing clustering on the elements based on attributes of the elements. The method may further comprise generating Geographic Information System, GIS, data by encoding the generated geometric data in a GIS format.

### TECHNICAL FIELD

The present disclosure relates to the processing of arbitrary data using one or more processors.

### BACKGROUND

With the increasing proliferation of computer technology, increasing amounts of data is being recorded and stored, resulting in large and complex data sets that are difficult to store, analyse and visualise. Traditional data processing techniques have been developed in the expectation of processing structured data but there has arisen a need to develop data processing techniques capable of processing arbitrary input data that may or may not be structured, and facilitate its storage, analysis and visualisation.

### SUMMARY

In accordance with the techniques of this disclosure, arbitrary data is converted to geometric data to allow the arbitrary data to viewed, interrogated or processed using tools and techniques developed for the viewing, interrogation or processing of geometric data. Optionally, the arbitrary data may be converted to synthetic geospatial data (Geographic Information System, GIS, data) to allow the arbitrary data to viewed, interrogated or processed using tools and techniques developed for the viewing, interrogation or processing of geospatial data. Advantageously, this permits the use of GIS platforms to ingest and operate on the data, the optimised storage of data by enabling prioritisation of features of significance in the GIS data, the use of existing mechanisms such as tile servers for storage and transport including the use of geometric regions within the GIS data for querying, and the compression and aggregation of data for storage/transport with GIS clustering mechanisms. Additionally, this may permit the visualisation of the arbitrary data in a meaningful navigable representation of the arbitrary data, such as through a synthetic virtual landscape representative of the arbitrary data.

According to a first aspect there is provided a method for processing data performed by one or more processors, the method comprising: receiving input data that comprises a plurality of elements, each element comprising a plurality of attributes; generating geometric data based on the input data by determining locations in a space for elements of the plurality of elements based on attributes of the elements and generating geometries in the space for the elements at the respective determined locations, wherein determining locations in the space for elements based on attributes of the elements comprises performing clustering on the elements based on attributes of the elements. Thus the generated geometric data comprises a space in which geometries associated with elements of the input data are located, the locations of the geometries within the space being determined based on attributes of the elements.

Optionally, the method may further comprise generating Geographic Information System, GIS, data by encoding the generated geometric data in a GIS format. The method may optionally further comprise performing one or more GIS processing operations on the generated GIS data. The one or more GIS processing operations may comprise a GIS data compression operation such as a GIS geometry simplification. Alternatively or additionally, the one or more GIS operations may comprise performing a spatial analysis on the GIS data such as determining a distance or area within the GIS data. Alternatively or additionally, the one or more GIS processing operations may comprise generating a plurality of map tiles based on the GIS data and, optionally, the method may further comprise providing one or more map tiles of the plurality of map tiles to a client for display by the client, wherein providing the one or more map tiles to a client may optionally comprise transmitting the one or more map tiles to the client over a computer network. Alternatively or additionally, encoding the generated geometric data in a GIS format may comprise encoding the generated geometric data in a vector-based GIS format. Alternatively or additionally, encoding the generated geometric data in a GIS format may comprise encoding the generated geometric data in a raster-based GIS format. Encoding the generated geometric data in a GIS format may comprise encoding the geometric data in a postGIS table, a shapefile, a map tile, or a comma-separated variable file.

Alternatively or additionally, generating the geometric data and/or GIS data from the input data may be a deterministic (repeatable or non-stochastic) process. Such a process is not reliant on randomisation, even by way of a random seed followed by procedural generation based on the random seed; for a given set of input data, the process may reliably and repeatedly produce the same output data. Optionally, determining locations in the space for the elements based on attributes of the elements may comprise, for each element, determining a location in space based on at least a subset of the attributes of the element. Optionally, determining a location in space for an element based on at least a subset of the attributes of the element is a reversible process such that the at least a subset of the attributes of the element are determinable based on the determined location of the element.

Alternatively or additionally, determining locations in the space for the elements may comprise determining two-dimensional or three-dimensional locations in the space for the elements.

Alternatively or additionally, determining locations in the space for the elements may comprise performing a Voronoi tessellation of the space and determining locations for the elements based on the Voronoi tessellation.

Alternatively or additionally, performing clustering on the elements based on attributes of the elements may comprise performing centroid-based clustering.

Alternatively or additionally, performing clustering on the elements based on attributes of the elements may comprise performing hierarchical clustering.

Alternatively or additionally, generating geometries in the space for the elements at the respective determined locations may comprise, for each element, generating a geometry at the determined location based on at least a subset of the attributes of the element. Optionally, for each element, generating a geometry at the determined location based on at least a subset of the attributes of the element may be a reversible process such that the at least a subset of the attributes of the element are determinable based on the geometry generated for the element.

Alternatively or additionally, generating geometries in the space for the elements at the respective determined locations may comprise, for each element, selecting a shape from among a plurality of different shapes based on at least a subset of the attributes of the element. Optionally, the plurality of shapes comprises a plurality of different two-dimensional shapes and each selected shape is a two-dimensional shape. Optionally, the method may further comprise generating a three-dimensional shape for each element based on the selected two-dimensional shape. Optionally, generating the three-dimensional shape may comprise, for each element, determining a thickness of the two-dimensional shape in a third dimension based on at least a subset of the attributes of the element.

Alternatively or additionally, the method may further comprise performing a geometric distortion on each of the generated geometries based on at least a subset of the attributes of the element associated with the generated geometry. Optionally, performing a geometric distortion on each of the generated geometries based on one or more attributes of the element associated with the generated geometry may comprise performing an affine transform on each of the generated geometries based on the at least a subset of the attributes of the element associated with the generated geometry.

Alternatively or additionally, the method may further comprise generating a visualisation representation based on the input data for display using a display device, such as a visualisation representation of the generated geometric data or a visualisation representation of the GIS data. Optionally, generating the visualisation representation may comprise three-dimensional rendering for display using a display device. Alternatively or additionally, the method may further comprise displaying the generated visualisation representation using a display device. Optionally, the generated visualisation representation may be a virtual reality, VR, visualisation and the display device may be a VR display device.

According to a further aspect there is provided a computer system, the computer system comprising one or more processors configured to: receive input data that comprises a plurality of elements, each element comprising a plurality of attributes; and generate geometric data based on the input data by determining locations in a space for elements of the plurality of elements and generate geometries in the space for the elements at the respective determined locations, wherein determining locations in the space comprises performing clustering on the elements based on attributes of the elements. Optionally the one or more processors may further be configured to generate Geographic Information System, GIS, data by encoding the generated geometric data in a GIS format.

The one or more processors may be configured to perform any of the above-described methods.

According to a further aspect there is provided a non-transitory computer-readable storage medium having instructions stored thereon that, when executed by one or more processors, cause the one or more processors to: receive input data that comprises a plurality of elements, each element comprising a plurality of attributes; and generate geometric data based on the input data by determining locations in a space for elements of the plurality of elements and generate geometries in the space for the elements at the respective determined locations, wherein determining locations in the space comprises performing clustering on the elements based on attributes of the elements. Optionally the instructions may, when executed, further cause the one or more processors to generate Geographic Information System, GIS, data by encoding the generated geometric data in a GIS format.

The instructions, when executed by one or more processors, may cause the one or more processors to perform any of the above-described methods.

### BRIEF DESCRIPTION OF THE DRAWINGS

The techniques of this disclosure, including aspects and embodiments, will be described in more detail by way of example only with reference to the accompanying drawings, in which:

FIG. 1 illustrates exemplary input data to which the techniques of this disclosure may be applied;

FIG. 2 illustrates the result of a clustering operation performed on the exemplary input data of FIG. 1;

FIG. 3 illustrates the result of determining positions in a two-dimensional plane for elements of the exemplary input data of FIG. 1;

FIG. 4 illustrates the determining of two-dimensional geometries for elements of the exemplary input data of FIG. 1;

FIG. 5 illustrates the positioning of the determined two-dimensional geometries in the two-dimensional plane;

FIG. 6 illustrates exemplary transformations that may be applied to the determined two-dimensional geometries; and

FIG. 7 illustrates a flow chart for a method in accordance with the techniques of this disclosure.

### DETAILED DESCRIPTION

The techniques of this disclosure generate geometric data and, optionally, ‘synthetic’ geospatial (or GIS) data from arbitrary input data. In some embodiments the input data is structured data, which may have a tabular format. Each record or ‘element’ within a table may have data values in one or more fields, wherein each data value is an ‘attribute’ of the element. As an example, the structured input data may take the form or a relational database. In some other embodiments the input data is unstructured data. Not all elements within the unstructured data have the same attributes as other elements. In some other embodiments the input data is semi-structured, which may be considered a hybrid between structured and unstructured data, in which metadata such as tags or semantic markers identify characteristics of elements and attributes within the input data. As an example, the semi-structured input data may be encoded according to a JSON (JavaScript Object Notation) or XML (Extensible Markup Language) format.

Attributes stored for each element may be purely numerical values, alphanumerical values, Boolean values, a selection of a value from a list of possible values (for example, an enumerated type), or may be more complex, such as multimedia data (image data, audio data, video data).

In some embodiments, the input data is graph data, such as input data in the form of a bipartite graph representing connections between two separate groups of nodes.

In some embodiments, the input data is a large data set, and may comprise more than 1 GB (gigabyte) of data, more than 10 GB of data, more than 100 GB of data, more than 1 TB (terabyte) of data, more than 10 TB of data, more than 100 TB of data, more than 1 PB (petabyte) of data, more than 10 PB of data, more than 100 PB of data, or more than 1 EB (exabyte) of data. The input data may comprise more than 10,000 elements, more than 100,000 elements, more than 1,000,000 elements, more than 10,000,000 elements, more than 100,000,000 elements, more than 1,000,000,000 elements, more than 10,000,000,000 elements, more than 100,000,000,000 elements, or more than 1,000,000,000,000 elements. Elements of the input data comprise a plurality of attributes and some or all elements of the input data may comprise more than 10 attributes, more than 100 attributes, more than 1000 attributes, more than 10,000 attributes, more than 100,000 attributes, or more than 1,000,000 attributes.

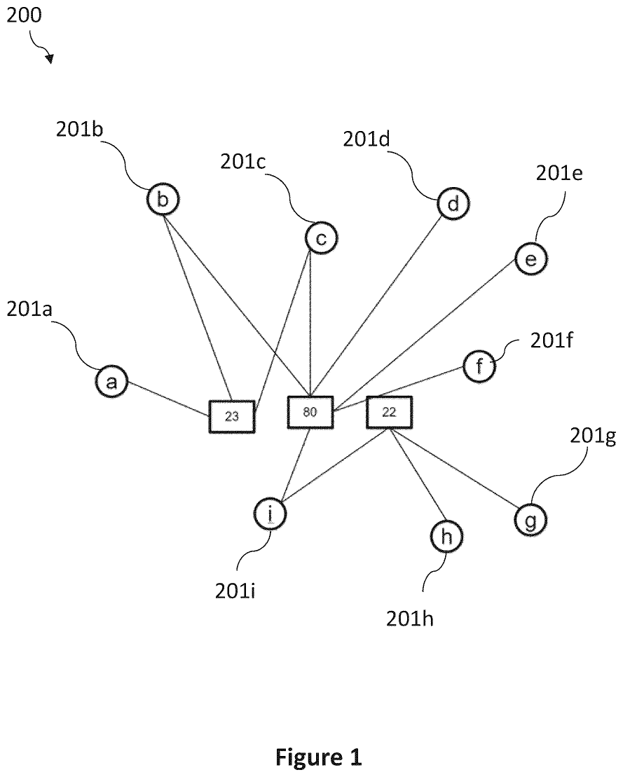

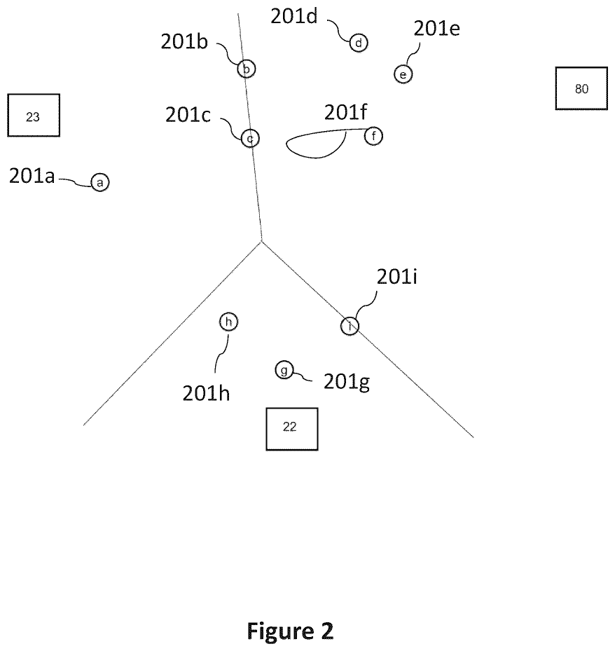

FIG. 1 illustrates a simple example of input data upon which the techniques of this disclosure will be demonstrated. FIG. 1 represents a computer network 200 comprising circles containing letters ‘a’ to ‘i’ which represent devices 201a to 201i as well as boxes containing the numbers ‘22’, ‘23’ and ‘80’. The boxes represent open ports and the number contained within a box indicates whether the port corresponding to that number is open. A line connection is shown between each of devices 201a to 201i and one of the boxes, the line connection indicating that the particular device has the particular port open. For example, device ‘a’ 201a has only port 23 open, and so a single connection is shown between ‘a’ and the box containing 23. Device ‘b’ 201b has ports 23 and 80 open and so two connections are shown extending from device ‘b’ 201b: a first connection to the box containing 23 and a second connection to the box containing 80. In this example, each of the devices has only one or two ports open, the one or two ports selected from the list of three, i.e. 22, 23 and 80. The input data represented by FIG. 2 takes the form of a bipartite graph.

To generate encoded GIS data from the input data, a cluster analysis is performed on the input data. The elements of the input data—the devices 201a to 201i in this case—are grouped based on their attributes—their port usage in this case. As each device 201a to 201i may have up to three ports open, each device is grouped with other devices in accordance with similarity in the attribute values, i.e. similarity in terms of which ports are open.

The grouping of the devices into clusters may, for example, be performed using a centroid-based clustering technique, such as by k-means clustering, or may be performed using a hierarchical-based clustering technique, or a combination thereof. In some embodiments, performing a cluster analysis may comprise performing a principal component analysis (PCA) on the input data as a means of dimensionality reduction, which may comprise performing a transformation on the input data to effect a change of basis. The selection of attributes by which the clustering is performed may be user-defined or may be detected automatically by, for example, a PCA or centroid-based clustering operation.

For the example data represented by FIG. 1, the devices are clustered based on their attributes (open ports) and located in a two-dimensional plane partitioned according to a Voronoi tessellation, with centroids of the tessellating triangles representing particular open ports, the devices located in the two-dimensional plane in accordance with the particular combinations of open ports. Therefore each of the elements of the input data is located in space based on at least a subset of its attributes.

FIG. 2 illustrates the generation of a number of neighbourhoods from the Voronoi tessellation and each of the devices located in a particular neighbourhood or on the border between neighbourhoods based on its particular open ports. FIG. 2 shows three neighbourhoods, each relating to one of the ports 22, 80, and 23. Device 201i has two ports open, 22 and 80, and therefore the device is located on the border of the neighbourhoods 22 and 80. Devices 201d, 201e and 201f are located in the neighbourhood 80, as they each only have port 80 open. A device is located in a particular area in space based on the particular ports open.

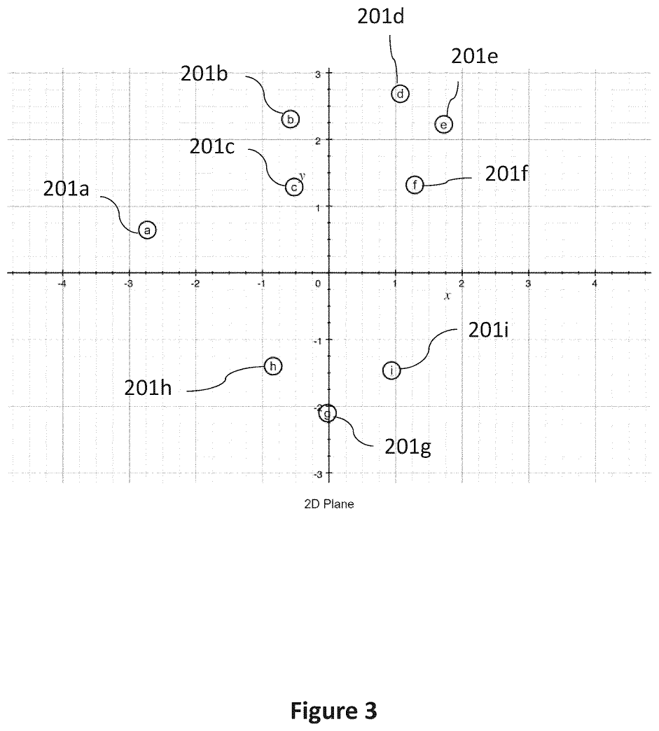

FIG. 3 shows a two-dimensional plane with x and y coordinates, wherein each of the devices is located at a particular point in two-dimensional space—a particular pair of x and y coordinate values according to the results of the clustering based on attributes of the device—in this case the open ports.

After determining a location in space for each element, a geometry is generated at that location based on one or more attributes of the element. The one or more attributes used to generate the geometry for an element may be different from the attributes used to determine a location for the element or may be the same attributes. It will be appreciated that the use of the same attributes may introduce redundancies but this may assist visualisation in some embodiments.

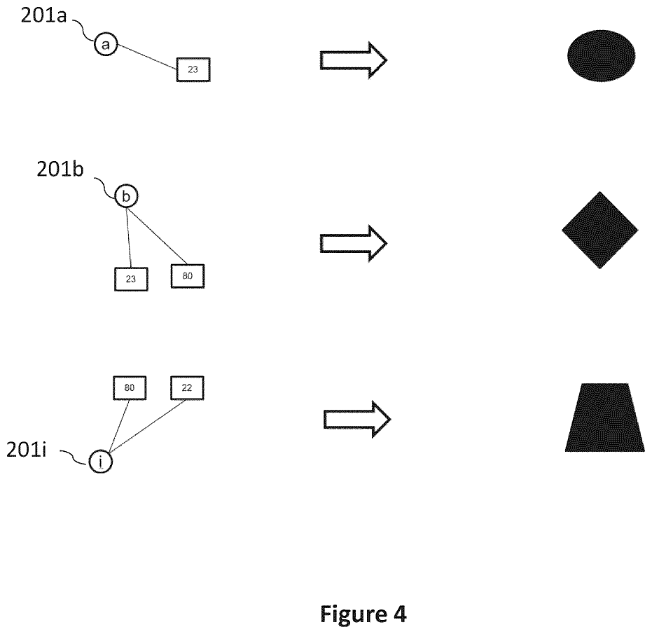

FIG. 4 shows examples of determining a geometry for each device, the determined geometry to be located at the x and y coordinates for the device, the determined geometry based on the particular open ports of the device. The geometries determined in FIG. 4 are two-dimensional geometries. FIG. 4 shows determining an oval shape geometry for a device having only port 23 open (such as device ‘a’ 201a), determining a square shape for a device having ports 23 and 80 open (such as device ‘b’ 201b), and determining a trapezium shape for a device having ports 80 and 22 open (such as device ‘i’ 201i). The generated geometries are thus representative of the attributes of each element. Elements with different attributes may therefore have different generated geometries.

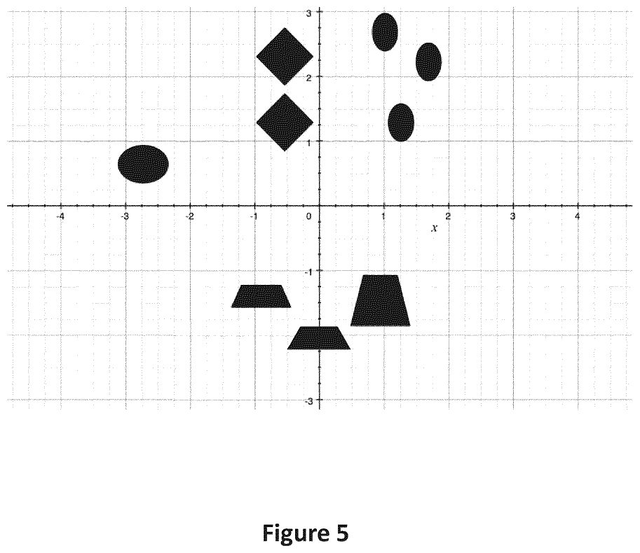

FIG. 5 illustrates the determining geometries for each element based on the attributes of the element and the location of the determined geometries at the location determined as a result of the clustering analysis. Based on the particular combination of open ports of a device, a particular location in space is determined and a particular geometry is generated and located at that particular location for the device.

In some embodiments, determining geometries comprises determining a geometry for each element based on one or more attributes of the element, which may be the same or different to the attributes used to locate the element in space. In some embodiments, determining a geometry for an element comprises selecting from a list of available geometries, such as a list of two-dimensional shapes, based on one or more attributes of the element. In other embodiments, determining geometries may comprise procedurally generating a complex shape based on one or more attributes of the element. In some embodiments, determining geometries may comprise determining three-dimensional geometries for the elements based on attributes of the elements.

Determining the geometries for the elements may further comprise transforming or distorting the generated geometries, wherein the transforming or distorting of the generated geometries may be based on one or more attributes of the element, which may be one or more different attributes than the attributes used to locate the element in space and/or to initially determine a geometry for the element.

In the example of the network input data of FIGS. 1 to 5, each device may have additional attributes in addition to open ports. For example, each device may have a further attribute that is the device's uptime. Generating the geometries for the elements may comprise performing a distortion or transformation based on one or more additional attributes such as a device's uptime. As an example, the two-dimensional shapes shown in FIG. 5 may be converted to three-dimensional shapes based on the one or more additional attributes. The two-dimensional shape for each device may be assigned a depth or thickness based on the one or more additional attributes. For example, the two-dimensional shape for each device may be ‘extruded’ in a z direction that is normal to the x-y plane to produce cylindrical and prismatic geometries at the determined x and y coordinates wherein the cylindrical and prismatic geometries have heights (i.e. elevations in the z direction) based on each device's uptime. The conversion from two-dimensional to three-dimensional shape is not required to be a simple ‘extrusion’ and may instead comprise generating shapes of non-constant thickness based on the one or more attributes, such as generating a conic or pyramidal shape having a height based on the one or more attributes, or may comprise generating a three-dimensional shape based on a full or partial revolution of the two-dimensional shape in accordance with the one or more additional attributes.

In addition to or instead of converting a two-dimensional geometry to a three-dimensional geometry, one or more transformations or mappings may be applied to a geometry determined for an element based on one or more attributes of the element, such as an affine transformation.

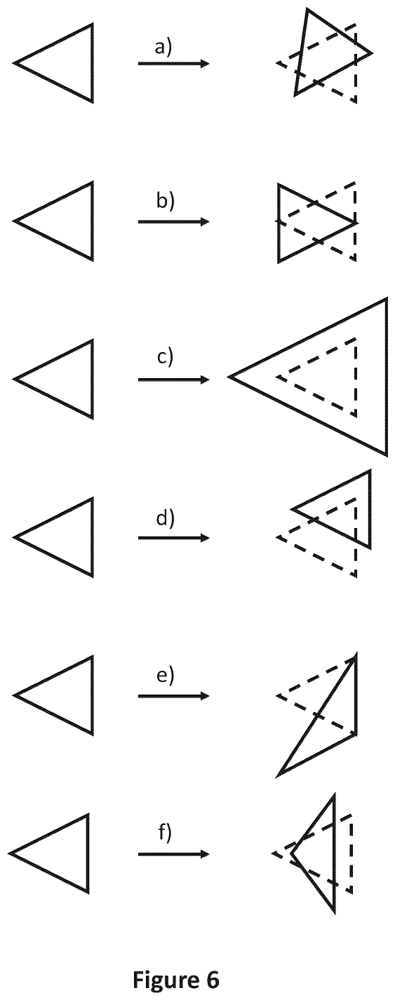

FIG. 6 illustrates examples of affine transformations that may be applied to a geometry associated with an element based on one or more attributes of the element. Transformation ‘a)’ represents a rotation transformation, where a geometry is rotated about a point in space, which may be the location for the geometry in space determined based on attributes of the associated element, or may be another point such as a point offset from the determined location. Transformation ‘b)’ represents a mirroring of the determined geometry—a reflection about a line. Transformation ‘c)’ represents a scaling of the determined geometry. Transformation ‘d)’ represents a translation of the determined geometry. Transformation ‘e)’ represents a shearing of the determined geometry. Transformation ‘f)’ represents a non-uniform scaling of the determined geometry such that the scaling factor is different in different directions. An affine transformation may comprise a single one of transformations ‘a)’ to ‘f)’ or a combination thereof. The transformation may be a function of the one or more attributes of the element, such as a degree of rotation based on the one or more elements, a binary decision of whether or not to mirror a geometry based on the one or more attributes of the element, a scaling factor based on the one or more attributes of the element, a distance or direction of translation based on the one or more attributes of the element, a degree of shearing based on the one or more attributes of the element, and scaling factors in multiple different directions for non-uniform scaling based on one or more attributes of the element. The use of affine transformations may help preserve detail in the geometry, creating a uniquely distorted shape while maintaining a meaningful similarity to other elements with similar attributes.

After generating geometries at locations in space based on the elements and attributes of the input data, Geographic Information System, GIS, data may optionally be generated by encoding the generated geometric data in a GIS format. This results in encoded GIS data that is representative of the computer network.

The encoded GIS data may be GIS data encoded according to any of a number GIS formats.

In some embodiments, the encoded GIS data is data encoded in a vector-based GIS format, in which the features of the data are encoded as points, lines and polygons. Three-dimensional representations of elements may have a two-dimensional footprint and an elevation, which may be a constant elevation over the extent of the footprint, or may be a non-constant elevation, in which the elevation may be represented by locally varying elevation values over the extent of the footprint, or may be represented by encoded contours or as a single encoded elevation value for the element as well as metadata defining how the elevation varies across the extent of the footprint as a function of the single encoded elevation value. Elevation values may additionally or alternatively be encoded using one or more triangulated irregular networks, where by a triangular mesh grid is used to encode elevation values at a number of vertices with coordinates in three dimensions, the vertices connected by edges to form a triangular tessellation of a region. For example, the encoded GIS data may be data encoded according to an Esri Shapefile format, or according to a Geographic JavaScript Object Notation (GeoJSON) format, or according to a Geography Markup Language (GML) format, or according to a Google™ Keyhole Markup Language format, or according to an IDRISI Vector format, or according to a MapInfo TAB format, or according to an OpenStreetMap OSM XML format, or according to a Digital Line Graph (DLG) format, or according to a Geographic Base File-Dual Independent Mask Encoding (GBF-DIME) format, or according to an ArcInfo Coverage format, or according to a CAD-based vector format such as an AutoCAD DXF format, or according to any combination of these or other vector-based GIS formats.

In some embodiments, the encoded GIS data is encoded in a raster-based GIS format, in which the features of the data, such as elevation, are encoded as point values in a raster grid. For example, the encoded GIS data may be encoded according to an ERDAS Imagine (IMG) format, or according to an ASCII Grid format, or according to a GeoTIFF format, or according to an IDRISI Raster format, or according to a Envi RAW Raster format, or according to PCI Geomatics Database File (PCIDSK) format, or according to an Esri Grid format, or according to any combination of these or other raster-based GIS formats. In some embodiments, the encoded GIS data is encoded in a compressed raster-based format, such as a lossy raster-based GIS format.

In some embodiments, the encoded GIS data is encoded in a geographic database file format, such as according to an Esri File Geodatabase format, or according to an OGC GeoPackage format, or according to a Mapbox MBTiles format, or according to a GE Smallworld Version Managed Data Store format, or according to a SpatiaLite format, or according to any combination of these or other geographic database GIS formats.

In some embodiments, the encoded GIS data includes metadata associating the elements of the input data and their attributes with their corresponding geometries in the encoded GIS data, which may include the attributes used to define the geometries and spatial location in the encoded GIS data, and/or may include other attributes that were not used to define the geometries and spatial location in the encoded GIS data.

The encoded GIS data may be processed using any suitable GIS technique. The techniques according to the present disclosure result in an output of ‘synthetic’ geospatial data that does not depend on geospatial input data, which enables the encoded GIS data to be further processed, such as by way of GIS processing techniques or GIS visualisation techniques.

In accordance with the techniques of this disclosure, the production of encoded (‘synthetic’) GIS data based on arbitrary input data may provide benefits to a human user analysing data. A visualisation representation of the encoded GIS data may be viewed directly using a three-dimensional rendering engine such as a real-time rendering engine that permits a user to navigate through the visualisation of the generated geometric data. The use of GIS-based visualisations, including virtual reality or augmented reality visualisations, allows the human user, for example, to more readily identify trends across the arbitrary input data that would not be apparent to the user based on the arbitrary input data in its original format. In the example presented above, where the input data represents a network of devices with certain ports open, a human user may trends in device statuses, such as particular combinations of open ports, which may facilitate the human user developing a greater awareness of device security within the network and any threats to the security. This analysis may be via a snapshot of the input data at a certain point in time, or may be via analysis of the data over time, developing a time-varying encoded GIS data set. In some embodiments the generated geometric data may be visualised without producing encoded (‘synthetic’) GIS data. The generated geometric data may be viewed directly using a three-dimensional rendering engine such as a real-time rendering engine that permits a user to navigate through the visualisation of the generated geometric data

In accordance with the techniques of this disclosure, the encoded GIS data may be further processed using GIS-specific data processing techniques.

As an example, a GIS-specific data compression operation may be performed on the encoded GIS data. Where the encoded GIS data is encoded in a vector-based GIS format, the data compression operation may include a geometry simplification. Such a geometry simplification may include identifying and removing elements (for example, points and/or line segments) of a geometry, such as elements of a contour or elements of a geometric model, to reduce feature complexity while retaining the general character and shape.

As another example, a spatial analysis may be performed on the encoded GIS data, such as determining a distance or area or calculating an optimum route (for example, shortest distance and/or minimum elevation change) through the encoded GIS data.

As another example, the encoded GIS data may be processed to generate a plurality of map tiles based on the encoded GIS data. Depending on whether the encoded GIS data is encoded in a vector-based or raster-based GIS format, the encoded map tiles may be vector or raster map tiles. The generation of the plurality of map tiles may include partitioning of a region into a plurality of tessellating tiles, such as into a plurality of tessellating squares, and generating content for each tile based on the content of the encoded GIS data in the region that corresponds to the tile. This process is repeated at a number of zoom levels, and so each point in the region is associated with a particular tile at each zoom level. Once the plurality of map tiles are generated, they may be provided from a server to client according to the part of the partitioned region that the client wishes to view. As a client pans or zooms around the region, different tiles are provided to the client. But, as the client pans and zooms, tiles that have previously been provided to the client remain relevant for the client's display. This means that the server does not need to provide data for an entirely new display as the client pans or zooms but only needs to provide tiles that are newly revealed following the client's pan or zoom. This may reduce bandwidth requirements between server and client, which may be particularly advantageous where the server and client represent different devices that are connected over a network. The server may be the same device that generated the encoded GIS data from the input data or may be a different device. The client and server may be applications in the same device or may be separate devices, such as separate devices connected over a network.

The embodiments discussed above illustrate the techniques of this disclosure by application to a simple example of input data, i.e. open ports of devices in a network. But it will be appreciated that the techniques of this disclosure are not limited to such input data and may be applied to other input data, such as other input data comprising multiple elements with each element comprising a plurality of attributes. By way of example, the input data may represent the behaviours of different nodes on a network, or traffic going in and out of a network. The techniques of this disclosure are not limited to the analysis of data derived from a telecommunications network. By way of example, the input data may comprise a set of elements wherein each element includes a text string that has metadata associated with it, and the text strings are clustered based on attributes they have, such as content of the text string including linguistic content and/or metadata.

In the embodiments discussed above, the geometries generated for an element may be distorted or transformed further based on one or more attributes of an element but it will be appreciated that this is an optional step and that, in some embodiments, the geometries are not distorted or transformed. Moreover, it will be appreciated that the final generated geometries that are encoded into the encoded GIS data are two-dimensional geometries. It will also be appreciated that the distortions or transformations discussed above, such as affine transformations, may be applied to three-dimensional geometries, whether they be three-dimensional geometries generated initially, such as by selection from among a plurality of three-dimensional geometries based on attributes of the associated element, or by procedural generation based on attributes of the associated element, or by a combination, such as by selecting a two-dimensional shape and converting it to a three-dimensional shape, e.g. by extrusion vertically. By way of example, a three-dimensional geometry may be rotated, scaled, sheared, mirrored etc. Moreover, it will be appreciated that multiple transformations may be applied, each based on different attributes of an element or based on different combinations of attributes of an element, of which some or all may or may not be the same attributes used to position the geometry in space or to determine the (pre-transformation) geometry at the determined position. Moreover, in some embodiments, different transformations are applied to different portions of a geometry, such as to different heights of an extruded two-dimensional shape, the different transformations being based on different attributes of the associated element.

In the embodiments discussed above, the position of a geometry in space is determined to be a two-dimensional position, i.e. a position in a two-dimensional plane. But it will be appreciated that the techniques of this disclosure are not limited to determining a position in a two-dimensional plane. For example, a position in three-dimensional space may be determined for an element based on attributes of the element and geometries may be determined for the element to be located at the determined position in three-dimensional space. In such embodiments, encoding GIS data may make use of multiple map layers to represent different z positions above and/or below a base x-y plane, with the geometries associated with elements encoded to different map layers according to the determined position in three-dimensional space.

In some embodiments, the position of elements in space may be determined using force-directed graph drawing techniques such as a spring model.

In some embodiments, the determining of positions of elements in space and/or the determining of geometries for the elements at the determined positions, may be a repeatable or non-stochastic process such that, at some or all steps in the method, the same input data reliably and repeatedly results in the same output data. In some embodiments, the determining of positions of elements in space and/or the determining of geometries for the elements at the determined positions may be a direct mapping such that some or all steps in the method are potentially reversible in that at least a portion of the input data (i.e. the input data that was used to generate the encoded GIS data) is recoverable from the encoded GIS data.

In some embodiments, the techniques disclosed herein may be applied to the same input data at different points (or periods) in time. Visualisation and post-processing techniques may then be applied to the outputted data to compare and analyse the data at different points in time, which may facilitate the identification of time-varying trends. The output encoded GIS data may comprise GIS data from different points (or periods) in time encoded at different map layers. In such embodiments it may be advantageous if the steps for determining positions of elements in space and the steps for determining geometries for the elements at the determined positions are the same for each point or period in time.

In some embodiments, the generation of geometries for elements may further include the determining of one or more textures or colours for the geometries based on attributes of the associated elements. The encoded GIS data may include the geometries textured or coloured based on the determined one or more textures or colours for each element.

In some embodiments, the geometries are generated for an element prior to determining a location in space for the element. In other embodiments the geometries are generated for an element after determining a location in space for the element. In some embodiments, operations are performed in parallel and both a location in space and a geometry may be determined for an element simultaneously.

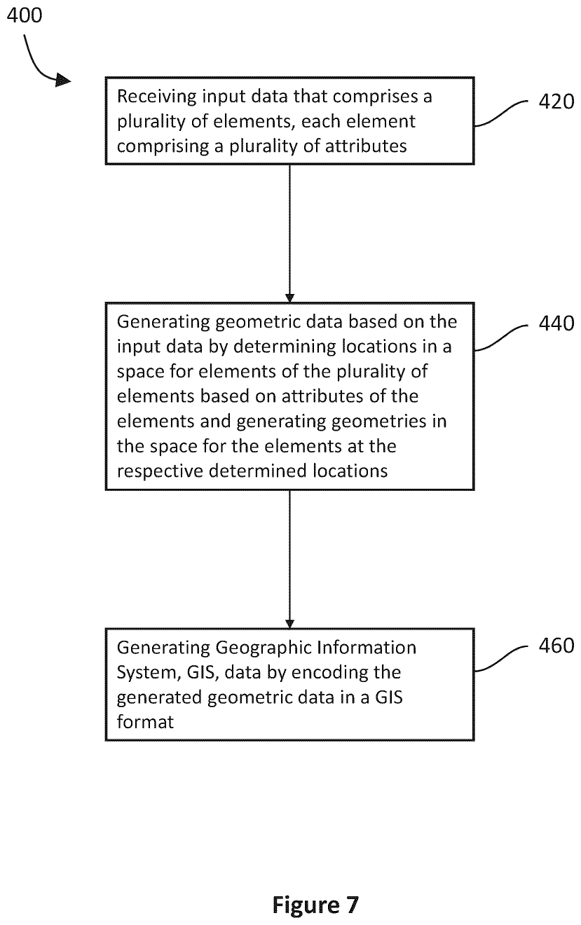

FIG. 7 illustrates a flow chart in accordance with the techniques of this disclosure. FIG. 7 illustrates a method 400, which may be performed using one or more processors. The method 400 includes a first step 420 that comprises receiving input data that comprises a plurality of elements, each element comprising a plurality of attributes. The method includes a second step 440 that includes generating geometric data based on the input data by determining locations in a space for elements of the plurality of elements based on attributes of the elements and generating geometries in the space for the elements at the respective determined locations, wherein determining locations in the space for elements based on attributes of the elements comprises performing clustering on the elements based on attributes of the elements. The method also includes a third step 460 that comprises generating Geographic Information System, GIS, data by encoding the generated geometric data in a GIS format. In some embodiments, a method in accordance with the techniques of this disclosure does not include the third step 460.

The steps of a method or algorithm described in connection with the embodiments disclosed herein, including but not limited to the method 400 illustrated in FIG. 7, may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium may be coupled to the processor such that the processor can read information from and/or write information to the storage medium. In an alternative, the storage medium may be integral to the processor. The processor and the storage medium may reside in an application-specific integrated circuit (ASIC). The ASIC may reside in a computing device or a user terminal. In the alternative, the processor and the storage medium may reside as one or more discrete components in a computing device or user terminal.

By way of example, the techniques of this disclosure may be embodied by a system comprising one or more computers or one or more processers configured to perform any of the methods described herein, including but not limited to the method 400 illustrated in FIG. 7. The techniques of this disclosure may also be embodied by a computer-readable medium having instructions stored thereon that, when executed by one or more processors, cause the one or more processors to perform any of the methods described herein, including but not limited to the method 400 illustrated in FIG. 7. The computer-readable medium may be a non-transitory computer-readable medium.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A method for processing data performed by one or more processors, the method comprising:
receiving input data that comprises a plurality of elements, each element comprising a plurality of attributes; and
generating geometric data based on the input data by determining locations in a space for elements of the plurality of elements based on attributes of the elements and generating geometries in the space for the elements at the respective determined locations, wherein determining locations in the space for elements based on attributes of the elements comprises performing clustering on the elements based on attributes of the elements.

2. The method of claim 1 further comprising generating Geographic Information System, GIS, data by encoding the generated geometric data in a GIS format and performing one or more GIS processing operations on the generated GIS data.

3. The method of claim 3 wherein the one or more GIS processing operations comprise one or more of:
a GIS data compression operation such as a GIS geometry simplification;
performing a spatial analysis on the GIS data such as determining a distance or area within the GIS data; and
generating a plurality of map tiles based on the GIS data and providing one or more map tiles of the plurality of map tiles to a client for display by the client.

4. The method of claim 2 wherein encoding the generated geometric data in a GIS format comprises encoding the generated geometric data in a vector-based GIS format and/or in a raster-based GIS format.

5. The method of claim 1 wherein generating the geometric data from the input data is a deterministic process, wherein determining locations in the space for the elements based on attributes of the elements comprises, for each element, determining a location in space based on at least a subset of the attributes of the element, and wherein determining a location in space for an element based on at least a subset of the attributes of the element is a reversible process such that the at least a subset of the attributes of the element are determinable based on the determined location of the element.

6. The method of claim 1 wherein determining locations in the space for the elements comprises determining two-dimensional or three-dimensional locations in the space for the elements, wherein determining locations in the space for the elements comprises performing a Voronoi tessellation of the space and determining locations for the elements based on the Voronoi tessellation.

7. The method of claim 1 wherein performing clustering on the elements based on attributes of the elements comprises performing centroid-based clustering and/or hierarchical clustering.

8. The method of claim 1 wherein generating geometries in the space for the elements at the respective determined locations comprises, for each element, generating a geometry at the determined location based on at least a subset of the attributes of the element,
wherein, for each element, generating a geometry at the determined location based on at least a subset of the attributes of the element is a reversible process such that the at least a subset of the attributes of the element are determinable based on the geometry generated for the element,
wherein generating geometries in the space for the elements at the respective determined locations comprises, for each element, selecting a shape from among a plurality of different shapes based on at least a subset of the attributes of the element,
wherein the plurality of shapes comprises a plurality of different two-dimensional shapes and each selected shape is a two-dimensional shape, the method further comprising generating a three-dimensional shape for each element based on the selected two-dimensional shape,
wherein generating the three-dimensional shape comprises, for each element, determining a thickness of the two-dimensional shape in a third dimension based on at least a subset of the attributes of the element.

9. The method of claim 1 further comprising performing a geometric distortion on each of the generated geometries based on at least a subset of the attributes of the element associated with the generated geometry, wherein performing the geometric distortion comprises performing an affine transform on each of the generated geometries based on the at least a subset of the attributes of the element associated with the generated geometry.

10. The method of claim 1 further comprising generating a visualisation representation based on the input data for display using a display device.

11. The method of claim 10 wherein generating a visualisation representation based on the input data comprises generating a visualisation representation of the generated geometric data that comprises a plurality of generated geometries that are each associated with a respective one of the elements of the input data.

12. The method of claim 10 further comprising generating Geographic Information System, GIS, data by encoding the generated geometric data in a GIS format, wherein generating a visualisation representation based on the input data comprises generating a visualisation representation of the GIS data, wherein the generating the visualisation representation comprises three-dimensional rendering for display using a display device.

13. The method of claim 10 further comprising displaying the generated visualisation representation using a display device, wherein the generated visualisation representation is a virtual reality, VR, visualisation and the display device is a VR display device.

14. A computer system, the computer system comprising one or more processors configured to:
receive input data that comprises a plurality of elements, each element comprising a plurality of attributes; and
generate geometric data based on the input data by determining locations in a space for elements of the plurality of elements and generate geometries in the space for the elements at the respective determined locations, wherein determining locations in the space comprises performing clustering on the elements based on attributes of the elements.

15. A non-transitory computer-readable storage medium having instructions stored thereon that, when executed by one or more processors, cause the one or more processors to:
receive input data that comprises a plurality of elements, each element comprising a plurality of attributes; and
generate geometric data based on the input data by determining locations in a space for elements of the plurality of elements and generate geometries in the space for the elements at the respective determined locations, wherein determining locations in the space comprises performing clustering on the elements based on attributes of the elements.
